(19) United States
(12) Patent Application Publication
(10) Pub. No.: US 2021/0293005 A1
(43) Pub. Date: Sep. 23, 2021

(54) WATER OR OTHER FLUID MANAGEMENT

(71) Applicant: Jonathan Salvatore Kallestad, Blaine, MN (US)

(72) Inventor: Jonathan Salvatore Kallestad, Blaine, MN (US)

(21) Appl. No.: 17/206,243

(22) Filed: Mar. 19, 2021

Related U.S. Application Data
(60) Provisional application No. 62/992,367, filed on Mar. 20, 2020.

(51) Int. Cl. E03B 7/08; G05D 7/06; E03B 7/07; G05B 15/02

(52) U.S. Cl. CPC E03B 7/08; G05B 15/02; E03B 7/077; G05D 7/0623

(57) ABSTRACT

Generally discussed herein are examples water or other fluid management techniques, such as to help prevent damage to water or other fluid management equipment or help in winterization of the water or other fluid management system.

### PRIORITY

This application claims the benefit of priority to U.S. Provisional Application Ser. No. 62/992,367, filed Mar. 20, 2020 which is incorporated by reference herein in its entirety.

### TECHNICAL FIELD

Examples generally relate to commercial or residential domestic, potable water, or irrigation management. Examples can provide assurance that domestic, potable water, or irrigation conduits will not be damaged, such as from expansion of freezing fluid.

### TECHNICAL BACKGROUND

An automatic irrigation system typically includes a controller that controls a valve, such as a solenoid valve. The controller opens and closes the valve in accord with a program. Opening the valve increases fluid flow to a dispensing device, typically a sprinkler head or drip device. Closing the valve decreases fluid flow to the dispensing device. The fluid to the irrigation system is from a source, typically a city water source or well. The amount of pressure provided by the fluid source may be insufficient for watering an entire geographic region. The geographic region can be split into zones. The pressure of the fluid provided by the source can be sufficient to supply each zone individually. Each zone is then provided with fluid sequentially.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed herein.

FIG. 1 illustrates a logical block diagram of a system for improved water management.

FIG. 2 illustrates, by way of example, a diagram of an embodiment of water management system.

FIG. 3 illustrates, by way of example, a diagram of an embodiment of a water or other fluid management system.

FIG. 4 illustrates, by way of example, a flow diagram of an embodiment of a method for water or other fluid management.

FIG. 5 illustrates, by way of example, a flow diagram of another embodiment of a method for water or other fluid management.

FIG. 6 illustrates, by way of example, a flow diagram of another embodiment of a method for water or other fluid management.

FIG. 7 illustrates, by way of example, a flow diagram of another embodiment of a method for water or other fluid management.

FIG. 8 shows a block diagram of an example of a computing device, in accord with one or more embodiments.

### DESCRIPTION OF EMBODIMENTS

Discussed generally herein are systems, devices, computer-readable media, and methods for improved water or other fluid management.

A problem associated with prior irrigation management systems is damage from fluid expansion at cold temperatures (at or below 32 degrees Fahrenheit or 0 degrees Celsius). The fluid expansion can cause a pipe, another conduit, or other equipment to fracture or break. The breaking can cause a fluid leak, a pressure reduction, or otherwise cause the water or other fluid management system to fail. Examples help prevent the damage caused by the fluid expansion.

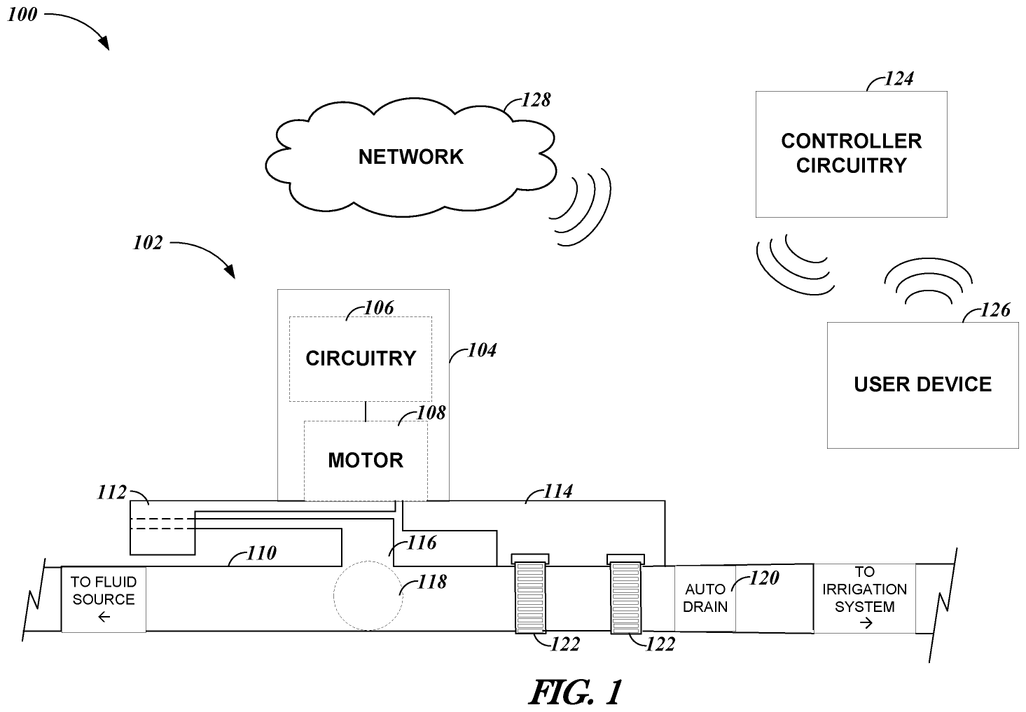

FIG. 1 illustrates a logical block diagram of a system 100 for improved water or other fluid management. The system 100 as illustrated includes an actuator 102, a conduit 110, controller circuitry 124, a user device 126, and a network 128. The actuator 102 is mechanically coupled to the conduit 110 and a handle 116 that controls an orientation of a disk 118. The disk 118, when oriented as shown allows fluid from a source to flow to a water or other fluid system. The disk 118, when oriented about perpendicular to the orientation shown, will block fluid from flowing to the water or other fluid system. The controller circuitry 124 can be communicatively coupled to at least one of the user device 126, the network 128, or circuitry 106 of the actuator 102.

The actuator 102 as illustrated includes a housing 104 around the circuitry 106 and a motor 108, an arm 112 mechanically coupled to the handle 116, and a stabilizing device 114 mechanically coupling the motor 108 and housing 104 to the conduit 110. The housing 104 can include metal, ceramic, plastic, polymer, or other material. The housing 104 can protect the circuitry 106 and the motor 108 from a surrounding environment. While the arm 112 is illustrated as extending towards the fluid source it can alternatively extend towards the auto drain 120. In such embodiments, the stabilizing device 114 and retention device 122 can be on the other side of the disk 118 than what is illustrated in FIG. 1.

The circuitry 106 can include one or more electric or electronic components. The electric or electronic components can include one or more transistors, resistors, capacitors, diodes, inductors, sensors (pressure, moisture, temperature, or the like), processors (e.g., central processing units (CPUs), application specific integrated circuits (ASICs), field programmable gate arrays (FPGA), graphics processing units (GPUs), or the like), radios (e.g., transmit, receive, or transceiver radios), antennas, modulators, demodulators, logic gates (e.g., AND, OR, XOR, negate, buffer, or the like), switches, multiplexers, power supplies (e.g., battery or wall power connector), or the like.

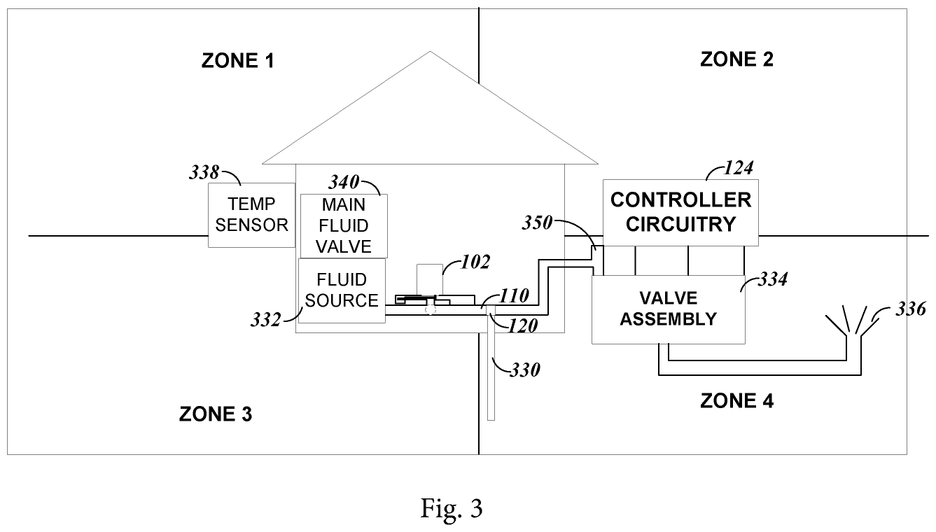

The circuitry 106 can be configured to receive data from at least one of the controller circuitry 124, the user device 126, or the network 128. The circuitry 106 can receive data that causes it to make the motor 108 move the arm 112. The arm 112 movement causes the handle 116 and the disk 118 to turn. The arm 112 movement causes either more or less fluid from the source 332 (see FIG. 3) to flow through the conduit 110.

The actuator 102 can be mechanically coupled to the conduit 110 through the stabilizing device 114 and a retention device 122. The stabilizing device 114 can prevent rotation of the housing 104 relative to the conduit 110. The stabilizing device 114 can include a metal, ceramic, plastic, polymer or other material. The stabilizing device 114 can include openings. The retention device 122 can retain the stabilizing device 114 to the conduit 110. The retention device 122 can include a collar, zip tie, band, or the like that can cause provide a force that retains the stabilizing device 114 to the conduit 110. The retention device can be threaded through the openings.

The auto drain valve 120, under the right conditions, can allow fluid to drain away from the water or other fluid system. The auto drain 120 valve can be any type of valve that allows water to drain from the water or other fluid system. The auto drain valve 120 can be a pressure biased auto drain valve. A pressure-biased auto drain valve opens, to allow backflow of fluid, when the pressure differential between the source side of the auto drain valve 120 and the water or other fluid system side of the auto drain valve 120 exceeds a threshold pressure. The auto drain valve 120 can be an electrically operable valve that opens and closes in relation to the electricity incident thereon. The auto drain valve 120 can be integrated as part of the conduit 110. The auto drain valve 120 can connect to the water or other fluid system separate from the electrically operable valve conduit 110. The auto drain valve 120 can be placed on the water supply line at a location suited for draining the water or other fluid system. The system 100 can include a drain line for directing water from the auto drain valve 120 to a drain or fluid retention device, such as a floor drain, a basin, or the like.

The controller circuitry 124 can include electric or electronic components similar to the circuitry 106. The controller circuitry 124 can be configured to control the water or other fluid system and fluid flow thereto. The controller circuitry 124 can electrically control a water valve to one or more zones of the water or other fluid system. The controller circuitry 124 can be programmed by a user, such as a user of the user device 126, water or other fluid system maintenance personnel, or another user.

The controller circuitry 124 can be coupled to the network 128. The controller circuitry 124 can access information available on the network 128. For example, the controller circuitry 124 can access temperature information, precipitation information, or the like, that is accessible through a website.

The user device 126 can include a computing device, such as a laptop computer, a tablet, a smartphone, desktop computer, television, thermostat, vehicle, or other computing device capable of communicating with the controller circuitry 124, the network 128, or the circuitry 106. The user device 126 can include communications circuitry configured to communicate with at least one of the controller circuitry 124, the network 128, or the circuitry 106.

The network 128 can include the Internet, a local area network (LAN), a wide area network (WAN), or the like. The network 128 can provide the user device 126, controller circuitry 124, or circuitry 106 with access to a webpage, a database, or the data.

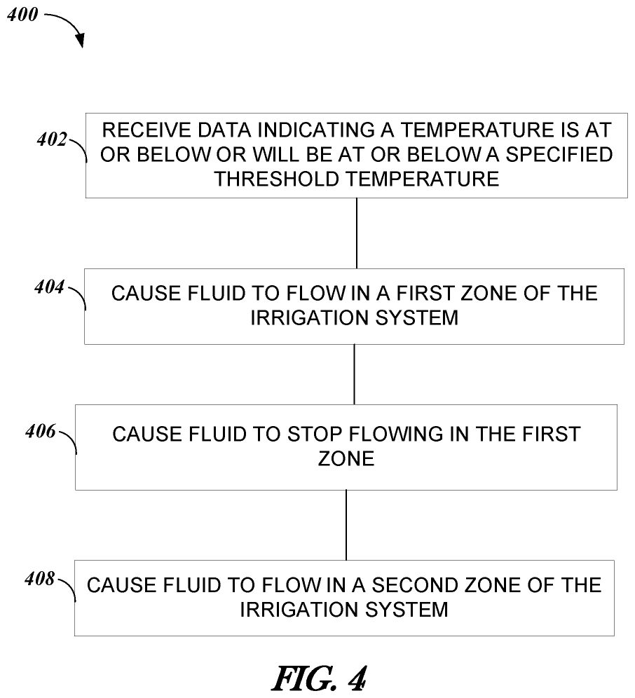

The system 100, or a subset of the system 100, provides improved water or other fluid system management options, such as to help avoid damage from freezing fluid or improved blowout, such as for winterization. One option includes configuring at least a portion of the system 100 to cycle fluid sequentially through zones of the water or other fluid system to help prevent fluid expansion caused by freezing. Another option includes activating the auto-drain 120 to help protect exposed parts of the water or other fluid system. Exposed parts of the water or other fluid system are backflow preventers, sprinklers, or other devices above a frost line. Yet another option includes implementing a season lockout mode that prevents the water or other fluid system from being inadvertently activated. Yet another option includes implementing a blowout program that efficiently winterizes the water or other fluid system. These are discussed in turn in FIGS. 4-7.

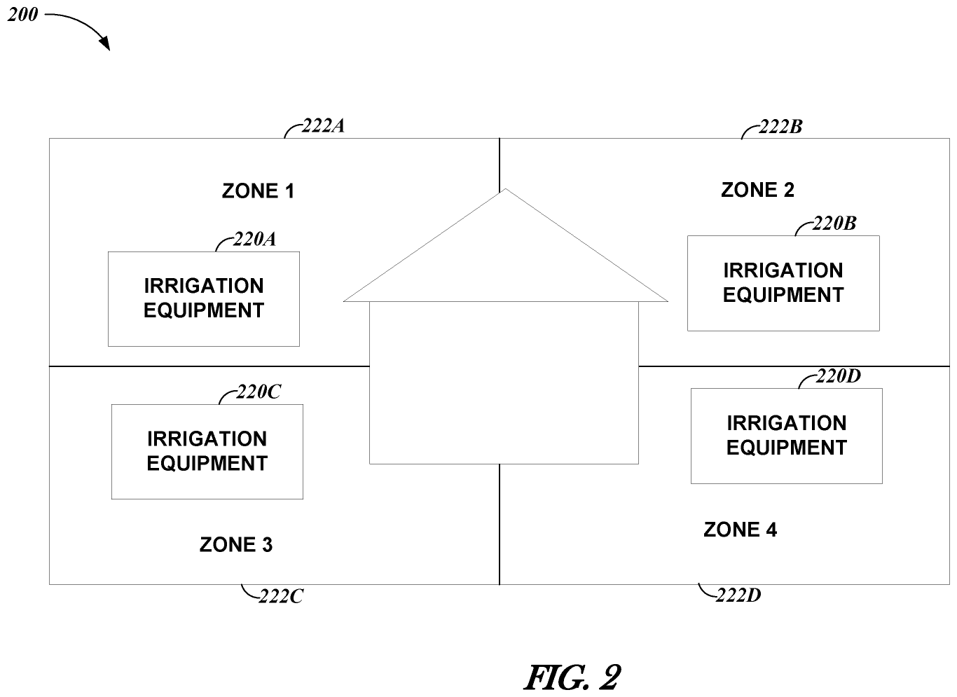

FIG. 2 illustrates, by way of example, a diagram of an embodiment of an irrigation system 200. While the remaining FIGS. discuss the techniques in terms of irrigation, they are applicable to other water or other fluid management. The system 200 as illustrated includes zones 222A, 222B, 222C, 222D of irrigation equipment 220A, 220B, 220C, 220D, respectively. The irrigation equipment 220A-22D in combination forms the irrigation system. A zone 222A-222D is a geographic region that can be serviced by the irrigation system without going over the fluid provision capability of the fluid source. A fluid source can be connected to the irrigation system using conduits of specified dimensions (length, width, height, diameter, etc.). The dimensions of the conduits can define how much fluid can be provisioned to the zone 222A-222D per unit time. Each sprinkler head or drip line has a specified amount of fluid pressure it requires to properly provide fluid. By comparing the total fluid provided to the total required by the irrigation system, the irrigation system can be split into zones 222A-222D that can be sufficiently provisioned by the irrigation system.

The irrigation equipment 220A-220D can include the conduits, fittings, sprinkler heads, drip lines, check valves, connectors, water supply valves, or the like of the irrigation system. The irrigation equipment 220A-220D of a zone 222A-222D can provide fluid sufficient for servicing the flora, water feature, or other landscaping of the zone 222A-222D.

FIG. 3 illustrates, by way of example, a diagram of an embodiment of an irrigation management system 300. The system 300 as illustrated includes a fluid source 332, a drain 330, a fluid dispensing device 336, a valve assembly 334, an actuator 102, and the controller circuitry 124. The irrigation equipment of only zone 4 is provided so as to not obscure the view.

The fluid source 332 provides the fluid for an irrigation system. The drain 330 provides a path for fluid disposal, such as to the ground, a sewer system, or the like. The valve assembly 334 includes solenoids or other valves coupled to the controller circuitry 124. The valve assembly 334 can include at least one valve per zone of the irrigation system. When a valve of the zone is open, fluid, such as air or water, can flow to the zone corresponding to the valve.

The fluid dispensing device 336 can include a water feature, a sprinkler head, a drip device, or the like. When the actuator 102 opens the conduit 110 to allow fluid through the conduit 110, and the valve assembly valve corresponding to the zone is also open, fluid can flow to the fluid dispensing device 336.

The system further includes a backflow preventer 350. The backflow preventer 350 is installed on a conduit to allow water to flow in one direction, and never in an opposite direction. The backflow preventer 350 typically prevents potable and non-potable fluids from mixing.

Components of the system that are at high risk for freezing include the dispensing device 336 and the backflow preventer 350. This is at least because they are typically above ground or near the surface of the ground. The portions of conduits coupled to the backflow preventer 350 and the dispensing device 336 and close to the ground surface (above the frost line) are also at high risk for damage from freezing if water is present.

FIG. 4 illustrates, by way of example, a flow diagram of an embodiment of a method 400 for irrigation management. The method 400 can be implemented using one or more of the components of FIGS. 1-3. The method 400 as illustrated includes receiving data indicating a temperature is at or below or will be at or below a specified threshold temperature, at operation 402. The data can be provided by the network 128, the user device 126, or a temperature sensor 338. The data can be provided to the controller circuitry 124, such as periodically, on a schedule, or on request of the controller circuitry 124 or the user device 126.

The method 400 as illustrated further includes, in response to the received data, automatically causing fluid to flow in a first zone of the irrigation system for a specified time, at operation 404. The operation 404 can include issuing a command, by the controller circuitry 124, to a valve of the valve assembly 334, that causes the valve to open. The fluid from the fluid source 332 can flow to, and out of, the dispensing device 336.

The method 400 as illustrated further includes automatically causing fluid to stop flowing in the first zone, at operation 406. The operation 404 can include issuing a command, by the controller circuitry 124, to a valve of the valve assembly 334, that causes the valve to close. The operation 406 can be performed after the specified time has elapsed.

The method 400 as illustrated further includes automatically causing fluid to circulate through a second zone of the irrigation system for another specified time, at operation 408. The operation 408 can include issuing a command, by the controller circuitry 124, to another valve of the valve assembly 334, that causes that valve to open. The specified time of operation 408 can be the same or different as the specified time of operation 404.

The method 400 can further include providing, by the controller circuitry 124, a notification to a user device 126 indicating that a temperature is below or will be below the specified threshold temperature. The method 400 can further include providing a notification to a user device 126 indicating that the fluid will be flowed through the irrigation system to help prevent damage from low temperatures. The method 400 can further include receiving data indicating the temperature is at or above the specified threshold temperature and in response, automatically stopping fluid from circulating through the irrigation system, such as by closing the conduit 110 using the actuator 102.

The operations of the method 400 can require a previous operation to be complete before performance. For example, the operation 408 can be performed in response to or after the operation 406 is completed.

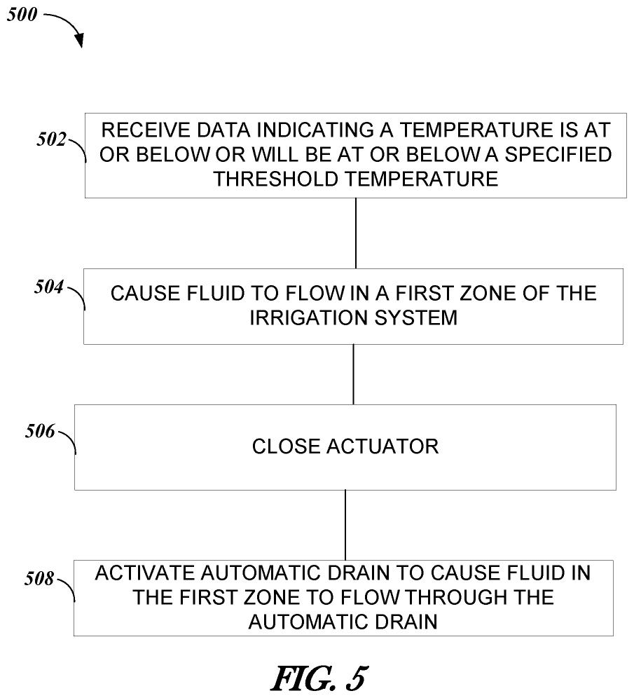

FIG. 5 illustrates, by way of example, a flow diagram of an embodiment of a method 500 for irrigation management. The method 500 can be implemented using one or more of the components of FIGS. 1-3. The method 500 as illustrated includes receiving data indicating a temperature is at or below or will be at or below a specified threshold temperature, at operation 502. The data can be provided by the network 128, the user device 126, or the temperature sensor 338. The data can be provided to the controller circuitry 124, such as periodically, on a schedule, or on request of the controller circuitry 124 or the user device 126.

The method 500 as illustrated further includes, in response to the received data, automatically causing fluid to flow in a first zone of the irrigation system, at operation 504. The operation 504 can include opening, by the controller circuitry 124, a valve of the valve assembly 334 and/or opening, by the actuator 102, the conduit 110. Automatic, as used herein, means without human interference after deployment.

The method 500 as illustrated further includes closing the conduit 110 coupled to the actuator 102, at operation 506. The operation 506 can be performed automatically.

The method 500 as illustrated further includes activating an automatic drain 120 to cause fluid in the first zone to flow through the automatic drain 120 to a drain 330 or a basin. Activating the automatic drain 120 can include providing an electrical signal that cause the automatic drain 120 to open, configuring the valves of the system 300 such that a pressure differential about the automatic drain 120 causes the automatic drain 120 to open or the like. The fluid can continue to flow in the zone (from operation 502) until the automatic drain 120 is open or until the automatic drain 120 is done draining.

The method 500 can further include providing a notification to a user device 126 indicating that temperatures are below or will be below the specified threshold temperature. The method 500 can further include providing a notification to a user device 126 indicating that the fluid will be drained through the irrigation system to help prevent damage from low temperatures.

The method 500 can further include automatically closing a solenoid (a valve of the valve assembly 334) to stop fluid flow in the first zone. The method 500 can further include opening the actuator 102. The method 500 can further include automatically causing fluid to circulate through a second zone of the irrigation system. The method 500 can further include closing the actuator 102. The method 500 can further include activating an automatic drain 120 to cause fluid in the first zone to flow through the automatic drain 120.

The method 500 can allow fluid in the backflow preventer 120, or other fluid in a high risk component, to drain through the drain 330. The operations of the method 500 can require a previous operation to be complete before performance. For example, the operation 508 can be performed in response to or after the operation 506 is completed. In another example, the operation 506 can be performed in response to or after the operation 504 is completed.

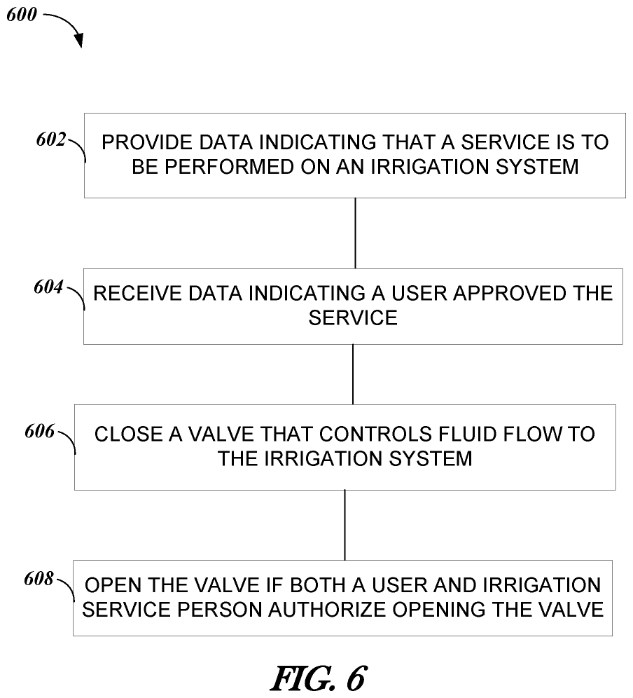

FIG. 6 illustrates, by way of example, a flow diagram of an embodiment of a method 600 for irrigation management. The method 600 can be implemented using one or more of the components of FIGS. 1-3. The method 600 as illustrated includes providing data indicating that a service is to be performed on the irrigation system, at operation 602. The data can be provided to a user device 126 of a user that owns, maintains, or is responsible for the irrigation system (hereafter “owner”). The data can be provided by a user device 126 of personnel that maintain the irrigation system (hereafter “contractor”).

The method 600 as illustrated further includes receiving data indicating a user approved the service, at operation 604. The data can be received at a user device 126 of the contractor. The data can be provided by a user device 126 of the owner. The owner can approve the service by selecting a software control on a user interface of the user device 126, providing a passcode through the user interface of the user device 126, a combination thereof, or the like.

The method 600 as illustrated further includes automatically closing a valve that controls fluid flow to the irrigation system, at operation 606. The operation 606 can include issuing a command, by the controller circuitry 124, to the actuator 102 that causes the actuator 102 to prohibit fluid flow through the conduit 110.

The method 600 as illustrated further includes (automatically) opening the valve only if both a user and an irrigation service person (the contractor) authorize opening of the valve, at operation 608. The authorization can be provided the user device 126, the network 128, or the like, to the controller circuitry 124. The authorization can include provision of a passcode, activation of a software control, or the like, through a user interface of the user device 126. The operation 608 can include the owner (via the user device 126) issuing a request to open the valve to a user device 126 of the contractor (or vice versa). The user or contractor can then be requested to provide a passcode or authorization to turn the valve back on. The passcode of the owner can be different from the passcode of the contractor. The method 600 can help ensure that the conduit 110 remains closed during times in which there is a risk of damage from freezing temperatures.

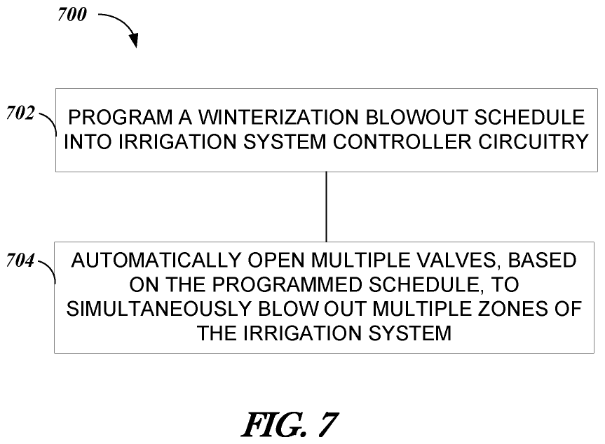

FIG. 7 illustrates, by way of example, a flow diagram of an embodiment of a method 700 for irrigation management. The method 700 can be implemented using one or more of the components of FIGS. 1-3. The method 700 as illustrated includes programming a winterization blow out schedule into irrigation system controller circuitry, at operation 702. The winterization blowout schedule can indicate to open multiple valves of the valve assembly 334 simultaneously. The winterization schedule can indicate a time to leave the valves of the valve assembly 334 open. The winterization schedule can indicate zones that cannot be blown out simultaneously.

The method 700 as illustrated further includes automatically opening multiple valves (of the valve assembly 334), based on the programmed schedule, to simultaneously blow out multiple zones of the irrigation system. The valves of the valve assembly 334 can be opened by issuing a command, by the controller circuitry 124, to the valve assembly 334.

The method 700 can include connecting a conduit pressurizing device to the irrigation system. The conduit pressurizing device can include an air compressor, or the like. The method 700 can include receiving (at the controller circuitry 124) data from a service personnel device that winterization of a zone of the multiple zones was completed. The method 700 can include, in response to or after receiving the data that winterization was completed, closing the multiple valves and opening another valve of the valve assembly.

The method 700 can further include, wherein programming the winterization schedule includes receiving, by controller circuitry 124 of the irrigation system, parameters of conduits of the irrigation system and the conduit pressurizing device and automatically determining which zones can be blown out simultaneously. The parameters can include a length, width, height, diameter, maximum pressure rating or the like of a conduit. The parameters can include a cubic feet per meter (CFM) of the conduit pressurizing device. The parameters can include a maximum power of a transformer that powers the irrigation system. The method 700 can further include storing the winterization schedule in a persistent memory.

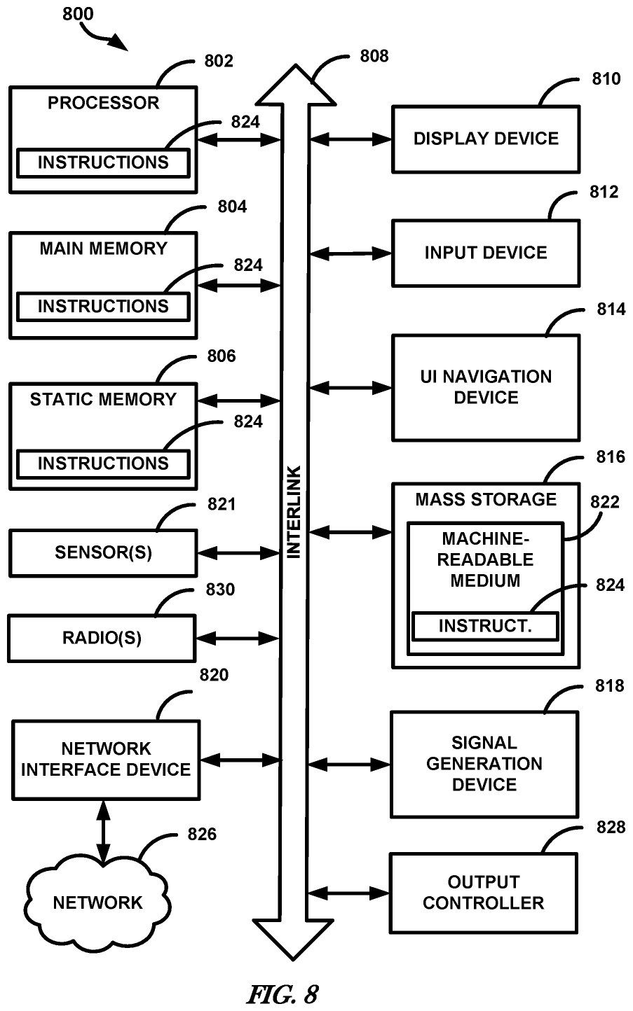

FIG. 8 shows a block diagram of an example of a computing device 800, in accord with one or more embodiments. The device 800 (e.g., a machine) may operate so as to perform one or more of the programming or communication techniques (e.g., methodologies) discussed herein. In some examples, the device 800 may operate as a standalone device or may be connected (e.g., networked) to perform one or more operations, such as those of FIGS. 4-7, or other component or operation of the FIGS. In other examples, the one or more items of the device 800 may be a part of the user device 126, the controller circuitry 124, the circuitry 106, the network 128, or the like, as discussed herein.

Embodiments, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively may be coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Device (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The device 800 may further include a display unit 810, an input device 812 (e.g., an alphanumeric keyboard), and a user interface (UI) navigation device 814 (e.g., a mouse). In an example, the display unit 810, input device 812 and UI navigation device 814 may be a touch screen display. The device 800 may additionally include a storage device (e.g., drive unit) 816, a signal generation device 818 (e.g., a speaker), a network interface device 820, and one or more sensors 821, such as a global positioning system (GPS) sensor, compass, accelerometer, or another sensor. The device 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). The device 800 may include one or more radios 830 (e.g., transmission, reception, or transceiver devices). The radios 830 may include one or more antennas to receive signal transmissions. The radios 830 may be coupled to or include the processor 802. The processor 802 may cause the radios 830 to perform one or more transmit or receive operations. Coupling the radios 830 to such a processor may be considered configuring the radio 830 to perform such operations. In general, an item being “caused” to perform an operation includes the item receiving data, interpreting the data as a command to perform an operation, and performing the operation. The signal does not have to be issued by the item that is causing the other item to perform the operation. Generally, “a first item causing a second item to perform an operation” means that the first item provided data that is already properly formatted to communicate with the second item or needs formatting and eventually becomes data that the second item receives and interprets as a command to perform the operation.

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the device 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824. The term “machine readable medium” may include any tangible medium that is capable of storing, encoding, or carrying instructions for execution by the device 800 and that cause the device 800 to perform any one or more of the techniques of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the device 800, and includes digital or analog communications signals or other intangible medium to facilitate communication of such software.

### EXAMPLES AND NOTES

The present subject matter may be described by way of several examples.

Example 1 may include a method of managing an irrigation system, the method comprising receiving data indicating a temperature is at or below or will be at or below a specified threshold temperature, in response to the received data, automatically causing fluid to flow in a first zone of the irrigation system for a specified time, automatically causing fluid to stop circulating in the first zone, and automatically causing fluid to flow through a second zone of the irrigation system for another specified time.

In Example 2, Example 1 can further include, wherein the fluid is provided to a fluid dispensing device in the first zone.

In Example 3, at least one of Examples 1-2 can further include providing a notification to a user device indicating that temperatures are below or will be below the specified threshold temperature.

In Example 4, at least one of Examples 1-3 can further include providing a notification to a user device indicating that the fluid will be flowed through the irrigation system to help prevent damage from low temperatures.

In Example 5, at least one of Examples 1-4 can further include receiving data indicating the temperature is at or above the specified threshold temperature and in response, automatically stopping fluid from flowing through the irrigation system.

Example 6 includes a method of managing an irrigation system, the method comprising receiving data indicating a temperature is at or below or will be at or below a specified threshold temperature, in response to the received data, automatically causing fluid to flow in a first zone of the irrigation system, closing a conduit coupled to an actuator, and activating an automatic drain to cause fluid in a backflow preventer to flow through the automatic drain.

In Example 7, Example 6 can further include providing a notification to a user device indicating that temperatures are below or will be below the specified threshold temperature.

In Example 8, at least one of Examples 6-7 can further include providing a notification to a user device indicating that the fluid will be drained through the irrigation system to help prevent damage from low temperatures.

In Example 9, at least one of Examples 6-8 can further include automatically closing a solenoid to stop fluid flow in the first zone, automatically causing fluid to circulate through a second zone of the irrigation system and activating an automatic drain to cause fluid in the second zone to flow through the automatic drain.

Example 10 includes a method of managing an irrigation system, the method comprising providing data indicating that a service is to be performed on the irrigation system, receiving data indicating a user approved the service, automatically closing a valve that controls fluid flow to the irrigation system, and opening the valve only if both a user and an irrigation service person authorize opening of the valve.

In Example 11, Example 10 can further include, wherein authorization of valve opening includes a passcode from the service person.

In Example 12, Example 11 can further include, wherein authorization of valve opening includes a request to open the valve from the user.

In Example 13, at least one of Examples 11-12 can further include, wherein authorization of valve opening includes a same or different passcode from the user.

Example 14 can include a method of managing an irrigation system, the method comprising programming a winterization blow out schedule into irrigation system controller circuitry, and automatically opening multiple valves, based on the programmed schedule, to simultaneously blow out multiple zones of the irrigation system.

In Example 15, Example 14 can further include connecting a conduit pressurizing device to the irrigation system.

In Example 16, at least one of Examples 14-15 can further include receiving data from a service personnel device that winterization of a zone of the multiple zones was completed.

In Example 17, at least one of Examples 14-16 can further include, wherein programming the winterization schedule includes receiving, by controller circuitry of the irrigation system, parameters of conduits of the irrigation system and the conduit pressurizing device and automatically determining which zones can be blown out simultaneously.

In Example 18, Example 17 can further include, wherein programming the winterization schedule includes receiving data indicating parameters of the transformer and checking, by the controller circuitry, whether the parameters of the transformer allow for blowing out multiple zones simultaneously.

In Example 19, at least one of Examples 14-18 can further include storing the winterization schedule in a persistent memory.

In Example 20 a system or device os configured to perform the method of at least one of Examples 1-19.

In Example 21, a non-transitory machine-readable medium includes instructions that, when executed by a machine, cause the machine to perform operation of at least one of Examples 1-19.

The above Description of Embodiments includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The flowchart and block diagrams in the FIGS. illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The functions or techniques described herein may be implemented in software or a combination of software and human implemented procedures. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Description of Embodiments, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Description of Embodiments as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A fluid management system comprising:
a processor;
a memory coupled to the processor, the memory including instructions that, when executed by the processor, cause the processor to perform operations comprising:
receiving data indicating a temperature about the fluid management system is or will be at or below a specified threshold temperature;
in response to the received data, automatically causing fluid to flow in a first zone of the fluid management system;
closing a conduit coupled to an actuator; and
activating an automatic drain to cause fluid in a backflow preventer to flow through the automatic drain.

2. The system of claim 1, wherein the operations further include providing a notification to a user device indicating the temperature is or will be below the specified threshold temperature.

3. The system of claim 1, wherein the operations further include providing a notification to a user device indicating that the fluid will be drained through the fluid management system to help prevent damage from low temperatures.

4. The system of claim 1, wherein the operations further comprise:
automatically closing a solenoid to stop fluid flow in the first zone;
automatically causing fluid to circulate through a second zone of the water or other fluid management system; and
activating an automatic drain to cause fluid in the second zone to flow through the automatic drain.

5. A method of managing a fluid management system, the method comprising:
programming a winterization blow out schedule into water or other fluid management system controller circuitry; and
automatically opening multiple valves, based on the programmed schedule, to simultaneously blow out multiple zones of the water or other fluid management system.

6. The method of claim 5, further comprising connecting a conduit pressurizing device to the water or other fluid management system.

7. The method of claim 5, further comprising receiving data from a service personnel device that winterization of a zone of the multiple zones was completed.

8. The method of claim 5, wherein programming the winterization schedule includes receiving, by controller circuitry of the water or other fluid management system, parameters of conduits of the water or other fluid management system and the conduit pressurizing device and automatically determining which zones can be blown out simultaneously.

9. The method of claim 8, wherein programming the winterization schedule includes receiving data indicating parameters of the transformer and checking, by the controller circuitry, whether the parameters of the transformer allow for blowing out multiple zones simultaneously.

10. The method of claim 5, further comprising storing the winterization schedule in a persistent memory.

11. A machine-readable medium including instruction that, when executed by a machine, cause the machine to perform operations for fluid management in a fluid management system, the operations comprising:
providing, to a user device, data indicating that a service is to be performed on the fluid management system;
receiving data indicating a user approved the service;
automatically closing a valve that controls fluid flow to the fluid management system; and
opening the valve only if both a user and a fluid management service person authorize opening of the valve.

12. The machine-readable medium of claim 11, wherein authorization of valve opening includes a passcode from the service person.

13. The machine-readable medium of claim 12, wherein authorization of valve opening includes a request to open the valve from the user.

14. The machine-readable medium of claim 13, wherein authorization of valve opening includes a same or different passcode from the user.
